(19) United States
(12) Patent Application Publication
(10) Pub. No.: US 2009/0102757 A1
(43) Pub. Date: Apr. 23, 2009

(54) APPARATUS AND METHOD TO COMPENSATE A DRIVING CURRENT OF A LIGHT EMITTING DIODE

(76) Inventors: Yu-Wen Chiou, Sinshih Township (TW); Biing-Seng Wu, Sinshih Township (TW); Lin-Kai Bu, Sinshih Township (TW)

Correspondence Address: HAYES SOLOWAY P.C., 3450 E. SUNRISE DRIVE, SUITE 140, TUCSON, AZ, 85718, US

(21) Appl. No.: 11/874,857

(22) Filed: Oct. 18, 2007

(51) Int. Cl. G09G 3/30

(52) U.S. Cl. 345/76

(57) ABSTRACT

The present invention discloses a method for driving a light emitting diode according to a required luminance, wherein an actual luminance of the light emitting diode decays with time and a correlation there between is represented by a life-time curve. The method comprises the following steps. First, the driving current is correlated with the required luminance by an initial coefficient is provided to the light emitting diode. Next, a length of a period of use of the light emitting diode is counted. Then, a slope of the life-time curve corresponding to the required luminance is stored. Finally, a new coefficient from the length of the period of use, the slope of the life-time curve and the initial coefficient is derived.

### FIELD OF THE INVENTION

The present invention relates to a driving apparatus and method thereof, and in particular, to a light emitting diode driving apparatus and method thereof.

### BACKGROUND OF THE INVENTION

Arrays of light emitting diodes (LEDs) create two-dimensional flat panel displays. LEDs can be adapted to create either monochrome or color displays and the LEDs may be formed on transparent or semiconductor substrates.

The light intensity for a specified driving current drops as an LED ages and different LEDs can degrade at different rates, causing a display to appear non-uniform. Typically, the intensity of light generated by LEDs is related to the current supplied to the LED. Therefore, providing different current to the LEDs can compensate for the intensity of the LED light. A typical technique that has been utilized to produce a uniform luminous flux in LEDs applications involves using a photosensor to provide feedback to the LEDs. The photosensor senses the LED light intensity and then sends a feedback signal to a drive circuit to adjust the current supplied to the LEDs. However, an additional photosensor is required in the typical technique, which increases the cost.

Therefore, what is needed is a system and method for driving LEDs that provides uniform luminous flux while meeting the cost requirement.

### SUMMARY OF THE INVENTION

The main purpose of the present invention is to provide a light emitting diode driving apparatus and method thereof that can vary the driving current in real time to compensate the different luminance due to the LED ages.

In accordance with the foregoing purpose, the present invention discloses a method for driving a light emitting diode according to a required luminance, wherein the actual luminance of the light emitting diode decays with time and a correlation there between is represented by a life-time curve. The method comprises the following steps. First, an initial coefficient is provided to the light emitting diode to correlate the driving current with the required luminance. Next, the length of time the LED is used is measured. Then, a slope of the life-time curve corresponding to the required luminance is stored. Finally, a new coefficient from the length of the period of use, the slope of the life-time curve and the initial coefficient is derived.

In accordance with another embodiment, an apparatus for driving a light emitting diode according to a required luminance is provided. The correlation between the decay in the luminosity of the LED and time is measured and represented on a life-time curve. The apparatus comprises a driving unit, a timer, a storage device and a processing unit. The driving unit provides the light emitting diode with a driving current correlated with the required luminance by an initial coefficient. The timer measures the period of time the LED is used. The storage device stores a slope of the life-time curve corresponding to the required luminance. The processing unit derives a new coefficient from the length of the period of use, the slope of the life-time curve and the initial coefficient

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a curve that indicates the relationship between the luminance and driving current for a LED.

FIG. 2 illustrates a life-time curve of a special LED whose luminance drops as this LED ages.

FIG. 3 illustrates different LED ages with different luminance-current curves.

FIG. 4 illustrates the flow chart to get the coefficient.

FIG. 5 illustrates a block diagram of an apparatus for driving a light emitting diode according to a required luminance.

### DETAILED DESCRIPTION OF THE PREFERRED EMBODIMENT

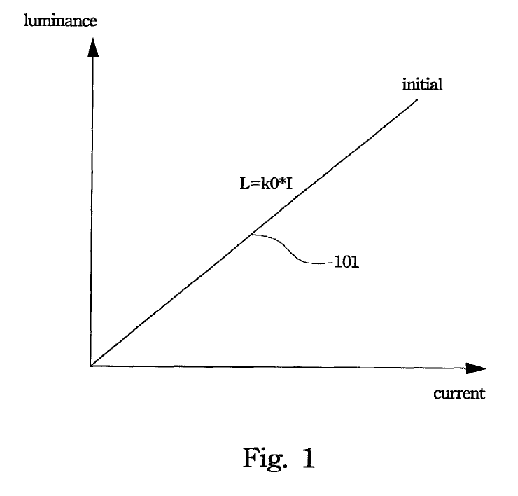

FIG. 1 illustrates a curve that indicates the relationship between the luminance and driving current for a LED. FIG. 1 shows different LEDs have different luminosities and driving current curves. The horizontal axis represents the driving current. The vertical axis represents the luminance. According to the curve 101, the luminance is proportional to the driving current for an LED. That is that the larger the driving current is, the larger the luminance is. The relationship between the luminance and the driving current is the following equation.

L=K×I

L is the luminance, I is the driving current and K is the slope of the curve and is a coefficient for getting the luminance in a driving current.

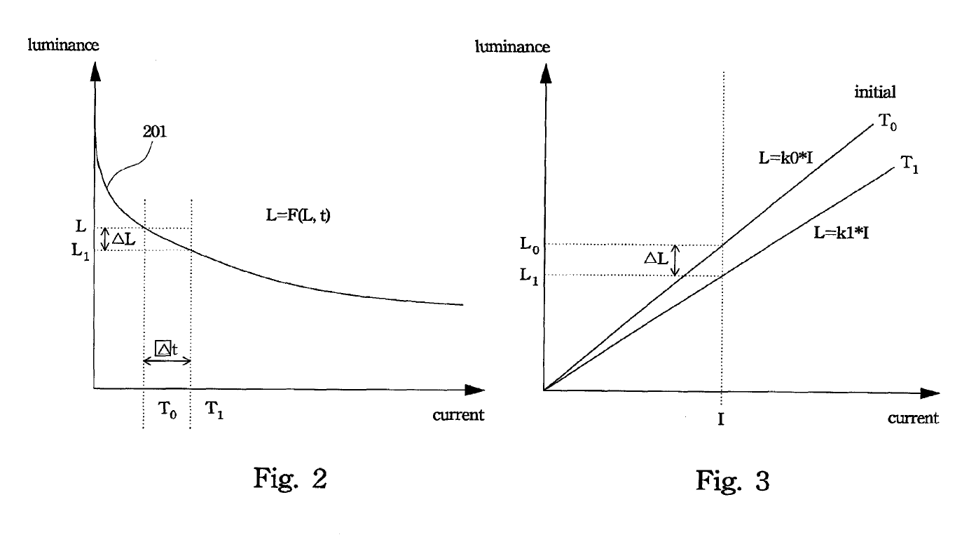

However, the luminance for a specified driving current drops as an LED ages. In other words, the luminance is related to not only the driving current but also the age of the LED. FIG. 2 illustrates a life-time curve of a special LED whose luminance drops as this LED ages. The horizontal axis represents the age of a LED. That is that the time for using the LED. The vertical axis represents the luminance. The life-time curve 201 is a function of the period of using LED and luminance as shown in the following equation.

L=F(L,t)

L is the required luminance, T is the time the LED is used.

Therefore, for a special LED, different LED ages have different luminance-current curves as shown in the FIG. 3. The slope drops as an LED ages. That is, in a special driving current, the older LED has a lower luminance. For example, the curve 301 represents the relationship between luminance and driving current of a special LED that is used initially, called at time T₀. The slope of the curve 301 is K₀. K₀ is a coefficient for getting the luminance in a driving current based on the curve 301. The curve 302 represents the relationship between luminance and driving current of this LED that has been used for a period, called at time T₁. The slope of the curve 302 is K₁. The K₁ is a coefficient for getting the luminance in a driving current based on the curve 302. The value of K₁ is less than that of the K₀. That means that, in a specified driving current I, the luminance of a LED at time T₀ is larger than that of a LED at time T₁.

The method disclosed in the present invention varies the driving current in real time to compensate for the different luminosities due to the LED ages. The following paragraphs explain the application of the present invention.

According to the FIG. 3, the luminance L₀ of a LED at time T₀ is equal to K₀ multiplied by the special driving current I.

L₀=K₀×I

The luminance L₁ of a LED at time T₁ is equal to K₁ multiplied by I.

L₁=K₁×I

The luminance difference ΔL is equal to the luminance L₀ to subtract the luminance L₁.

ΔL=L₀−L₁=(K₀−K₁)×I

L₀−ΔL=K₁×I

(L₀−ΔL)/L₀=K₁/K₀ (1)

On the other hand, according to FIG. 2, the luminance of the LED at time T₀ is L₀. The luminance of the LED at time T₁ is L₁. The slop of the curve 201 from time T₀ to time T₁ is equal to the following equation.

(L₁−L₀)/(T₁−T₀)=ΔL/ΔT=F′(L) (2)

F′(L) is the slop of the life-time curve 201 corresponding to the required luminance with respect to the period of use. The slope of the life-time curve 201 is the degradation degree of the luminance in a special period for using the LED.

From equation (1) and equation (2), the equation to indicate the relationship among the two coefficients, K₀ and K₁, and the time period that the LED has been used is shown in the following.

$${K}_{1} = {K}_{0} \times ( 1 - \frac{\vert {F}^{′} ( L ) Δ t \vert}{L} ) \qquad ( 3 )$$

K₀ is the coefficient of the LED that is used initially. K₁ is the coefficient of the LED that has been used for a time period Δt. F′(L) is the slop of the life-time curve corresponding to the required luminance with respect to the time period Δt. Δt is the length of the period of use. L is the actual luminance at the period of use.

In other words, based on the equation (3), the value of the coefficient K₁ can be calculated by the coefficient K₀, the time period that the LED has been used, F′(L) and the actual luminance. Then, the required driving current to drive the LED to illuminate the actual luminance can be calculated. By varying the driving current in real time, the different luminance due to the LED ages can be compensated.

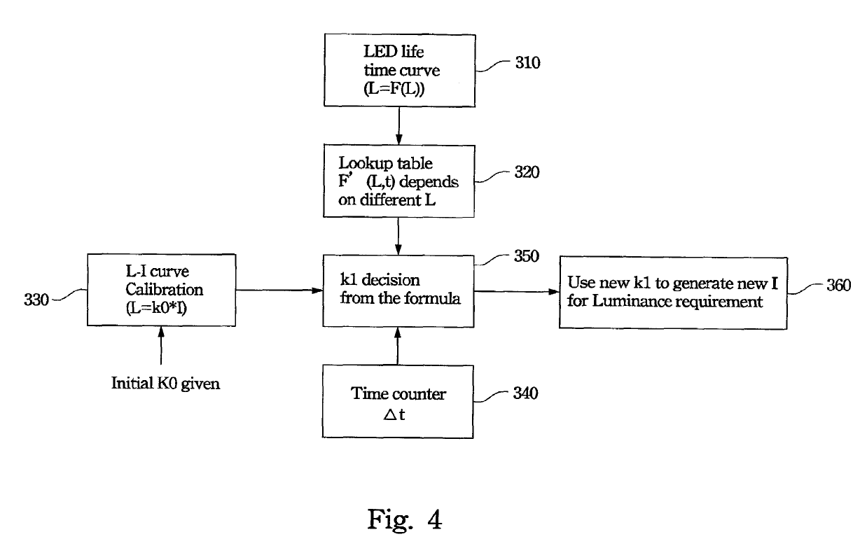

FIG. 4 illustrates the flow chart to get the coefficient K₁. In step 310, a special LED is used to build a life-time curve 201 as shown in the FIG. 2. It is noticed that the life-time curve 201 also can be built by a batch of LEDs. The curve 201 indicates a special LED in a special driving current whose luminance drops as this LED ages. In step 320, a lookup table is built based on the curve 201. This look up table records the values of slope of the curve 201 based on different luminance.

On the other hand, in step 330, a luminance-driving current curve 101 of the special LED is built as shown in the FIG. 1. The luminance-driving current curve 101 has a slope K₀ that is the initial coefficient for calculating the luminance for a driving current when the LED is just used. Moreover, in step 340, a timer is used to count a time period Δt that is the period the LED been used.

In step 350, a new coefficient K₁ can be calculated based on the equation (3) using the coefficient K₀, the time period Δt, F′(L) value and the actual luminance. The F′(L) value is from the lookup table in step 320. Finally, in step 360, a driving current to drive the LED to illuminate the required luminance can be got by dividing the required luminance with the new coefficient K₁.

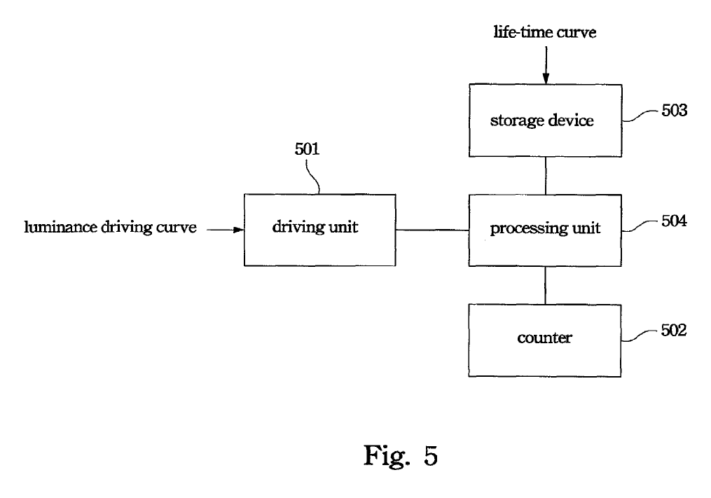

FIG. 5 illustrates a block diagram of an apparatus for driving a light emitting diode according to a required luminance. The apparatus includes a driving unit 501, a timer 502, a storage device 503 and a processing unit 504.

A special LED is used to build a life-time curve 201 as shown in the FIG. 2. It is noticed that the life-time curve 201 also can be built by a batch of LEDs. The values of slope of the curve 201 based on different luminance are calculated and are stored in the storage device 503. The driving unit 501 delivers a driving current to a light emitting diode. The driving current is derived from a coefficient. In an embodiment, the driving unit 501 delivers a driving current correlated with the required luminance by an initial coefficient to the light emitting diode. The counter 502 measures the time period the LED is used. The processing unit 504 uses the initial coefficient, the time period and the slope to get a new coefficient. The driving unit delivers a driving current derived from the new coefficient to the light emitting diode.

While the preferred embodiment of the invention has been illustrated and described, it will be appreciated that various changes can be made therein without departing from the spirit and scope of the invention.

What is claimed is:

1. A method for driving a light emitting diode according to a required luminance, wherein an actual luminance of the light emitting diode decays with time and a correlation there between is represented by a life-time curve, the method comprising the steps of:
providing the light emitting diode with a driving current correlated with the required luminance by an initial coefficient;
counting a length of a period of use of the light emitting diode;
storing a slope of the life-time curve corresponding to the required luminance; and
deriving a new coefficient from the length of the period of use, the slope of the life-time curve and the initial coefficient.

2. The method as claimed in claim 1, wherein the slope of the life-time curve is stored in a lookup table.

3. The method as claimed in claim 1, wherein the life-time curve is statistically obtained from a plurality of sample light emitting diodes.

4. The method as claimed in claim 1, wherein the coefficient is:
$${K}_{0} \times ( 1 - \frac{\vert {F}^{′} ( L ) Δ t \vert}{L} )$$
; where K₀ is the initial coefficient, F′(L) is the slop of the life-time curve corresponding to the required luminance with respect to the period of use, Δt is the length of the period of use, and L is the actual luminance at the period of use.

5. The method as claimed in claim 4, wherein the coefficient is smaller than K0.

6. The method as claimed in claim 1, further comprising a step to derive a driving current from the new coefficient to drive the light emitting diode.

7. An apparatus for driving a light emitting diode according to a required luminance, wherein an actual luminance of the light emitting diode decays with time and a correlation there between is represented by a life-time curve, the apparatus comprising:
a driving unit providing the light emitting diode with a driving current correlated with the required luminance by an initial coefficient,
a timer counting a length of a period of use of the light emitting diode;
a storage device storing a slope of the life-time curve corresponding to the required luminance; and
a processing unit deriving a new coefficient from the length of the period of use, the slope of the life-time curve and the initial coefficient.

8. The apparatus as claimed in claim 7, wherein the storage device is a lookup table.

9. The apparatus as claimed in claim 7, wherein the life-time curve is statistically obtained from a plurality of sample light emitting diodes.

10. The apparatus as claimed in claim 7, wherein the coefficient is:
$${K}_{0} \times ( 1 - \frac{\vert {F}^{′} ( L ) Δ t \vert}{L} )$$
; K₀ is the coefficient initially used by the driving unit, F′(L) is the slop of the life-time curve corresponding to the required luminance with respect to the period of use, Δt is the length of the period of use, and L is the actual luminance at the period of use.

11. The apparatus as claimed in claim 10, wherein the coefficient is smaller than K0.

12. The apparatus as claimed in claim 7, wherein the driving unit delivers a driving current derived from the new coefficient to the light emitting diode.
